(19) United States
(12) Patent Application Publication
(10) Pub. No.: US 2016/0279741 A1
(43) Pub. Date: Sep. 29, 2016

(54) LEAD-FREE SOLDER ALLOY, ELECTRONIC CIRCUIT BOARD, AND ELECTRONIC CONTROL DEVICE

(71) Applicant: TAMURA Corporation, Tokyo (JP)

(72) Inventors: Tsuyoshi UKYO, Yokohama-shi (JP); Tatsuya KIYOTA, lruma-shi (JP); Masaya ARAI, lruma-shi (JP); Naoko MATSUO, lruma-shi (JP); Tsukasa KATSUYAMA, lruma-shi (JP); Kota HATTORI, lruma-shi (JP)

(73) Assignee: TAMURA Corporation, Tokyo (JP)

(21) Appl. No.: 15/073,570

(22) Filed: Mar. 17, 2016

(30) Foreign Application Priority Data
Mar. 24, 2015 (JP) 2015-061792
Mar. 1, 2016 (JP) 2016-038976

(51) Int. Cl. B23K 35/26; C22C 13/02

(52) U.S. Cl. CPC B23K 35/262; C22C 13/02

(57) ABSTRACT

A lead-free solder alloy includes: 1 wt % to 4 wt % of Ag; 0.5 wt % to 1 wt % of Cu; 1 wt % to 5 wt % of Sb; 0.05 wt % to 0.25 wt % of at least one of Ni and Co; and Sn.

### CROSS-REFERENCE TO RELATED APPLICATIONS

The present application claims priority under 35 U. S. C. §119 to Japanese Patent Application No. 2015-061792, filed Mar. 24, 2015, entitled “LEAD-FREE SOLDER ALLOY, ELECTRONIC CIRCUIT BOARD, AND ELECTRONIC CONTROL DEVICE” and Japanese Patent Application No. 2016-038976, filed Mar. 1, 2016, entitled “LEAD-FREE SOLDER ALLOY, ELECTRONIC CIRCUIT BOARD, AND ELECTRONIC CONTROL DEVICE.” The contents of these applications are incorporated herein by reference in their entirety.

### BACKGROUND OF THE INVENTION

1. Field of the Invention

The present invention relates to a lead-free solder alloy, an electronic circuit board, and an electronic control device.

2. Discussion of the Background

In the related art, a solder joining method using a solder paste composition is employed at the time of joining an electronic part to an electronic circuit formed on a printed wiring board or a silicon wafer substrate. In general, as the solder paste composition, a solder alloy including lead was used. However, since the use of lead has been restricted by RoHS directive or the like from the viewpoint of environmental loads, a solder joining method using a so-called lead-free solder alloy including no lead has become common in recent years.

As the lead-free solder alloy, for example, Sn—Cu, Sn—Ag—Cu, Sn—Bi, and Sn—Zn solder alloys are well known. Among the alloys, an Sn-3Ag-0.5Cu solder alloy is much used for consumer electronic equipment to be used in televisions, mobile phones, or the like and in-vehicle electronic equipment to be mounted on vehicles.

Methods of increasing strength of a lead-free solder alloy by adding Ag or Bi to the solder alloy having Sn as base material are disclosed in several documents (see JP H5-228685 A, JP H9-326554 A, JP 2000-190090 A, JP 2000-349433 A, JP 2008-28413 A, WO 2009/011341 A, and JP 2012-81521 A).

### SUMMARY

According to one aspect of the present invention, a lead-free solder alloy includes: 1 wt % to 4 wt % of Ag; 0.5 wt % to 1 wt % of Cu; 1 wt % to 5 wt % of Sb; 0.05 wt % to 0.25 wt % of at least one of Ni and Co; and Sn.

According to another aspect of the present invention, an electronic circuit board includes a solder joint including a lead-free solder alloy. The lead-free solder alloy includes: 1 wt % to 4 wt % of Ag; 0.5 wt % to 1 wt % of Cu; 1 wt % to 5 wt % of Sb; 0.05 wt % to 0.25 wt % of at least one of Ni and Co; and Sn.

According to further aspect of the present invention, an electronic control device includes the electronic circuit board having a solder joint. The solder joint includes a lead free solder alloy including: 1 wt % to 4 wt % of Ag; 0.5 wt % to 1 wt % of Cu; 1 wt % to 5 wt % of Sb; 0.05 wt % to 0.25 wt % of at least one of Ni and Co; and Sn.

### BRIEF DESCRIPTION OF DRAWINGS

A more complete appreciation of the invention and many of the attendant advantages thereof will be readily obtained as the same becomes better understood by reference to the following detailed description when considered in connection with the accompanying drawings.

FIG. 1 is a partial cross-sectional view illustrating a part of an electronic circuit board according to an embodiment of the present invention; and

FIG. 2 is a cross-sectional photograph of a chip register in which electrode flaking of an electronic part is seen in Comparative Examples of an embodiment of the present invention.

### DESCRIPTION OF THE EMBODIMENTS

The embodiments will now be described with reference to the accompanying drawings, wherein like reference numerals designate corresponding or identical elements throughout the various drawings.

Hereinafter, a lead-free solder alloy, an electronic circuit board and an electronic control device according to an embodiment of the present invention will be described in detail. Naturally, the gist of the present invention is not limited to the following embodiment.

(1) Lead-free Solder Alloy

The lead-free solder alloy of this embodiment includes 1 wt % to 4 wt % of Ag, 0.5 wt % to 1 wt % of Cu, 1 wt % to 5 wt % of Sb, 0.05 wt % to 0.25 wt % of at least one of Ni and Co; and Sn.

The lead-free solder alloy of this embodiment can include 1 wt % to 4 wt % of Ag. By the addition of Ag, an Ag₃Sn compound precipitates in Sn-grain boundaries of the lead-free solder alloy and thus mechanical strength can be imparted.

However, when the content of Ag is less than 1 wt %, it is not preferred because the Ag₃Sn compound is unlikely to be precipitated and the lead-free solder alloy is reduced in mechanical strength and thermal impact resistance. In addition, when the content of Ag exceeds 4 wt %, it is not preferred because elongation properties of the lead-free solder alloy is deteriorated and electrode flaking may be caused in electronic parts by a solder joint formed using the same content.

Furthermore, when the content of Ag is 2 wt % to 3.8 wt %, the balance of the strength and the elongation properties of the lead-free solder alloy can be further improved.

The lead-free solder alloy of this embodiment can include 0.5 wt % to 1 wt % of Cu. By the addition of Cu in this range, a Cu erosion preventing effect is exhibited on a Cu land of an electronic circuit, and a Cu₆Sn₅ compound precipitates in Sn-grain boundaries whereby the lead-free solder alloy can be improved in thermal impact resistance. In this embodiment, the content of Cu is particularly preferably 0.5 wt % or 0.9 wt % to 1 wt %.

However, the Cu erosion preventing effect is not sufficiently obtained when the content of Cu is less than 0.5 wt %, and the precipitation of Cu₆Sn₅ compound is concentrated in the vicinity of a joined interface and joining reliability is also reduced when the content of Cu exceeds 1 wt %, whereby the lead-free solder alloy is deteriorated in elongation properties. Therefore, the content of Cu is not preferred in above these ranges.

In addition, when the content of Cu is particularly 0.5 wt %, the Cu erosion preventing effect can be exhibited on the Cu land, the viscosity of the lead-free solder alloy can be maintained in good condition during melting, occurrence of voids can be suppressed at the time of reflow, and the thermal impact resistance of the solder joint to be formed can be improved.

Further, when the content of Cu is 0.9 wt % to 1 wt %, the Cu erosion preventing effect can be sufficiently exhibited on the Cu land, and the diffusion of Cu is prevented from the Cu land to the molten lead-free solder alloy, whereby it is possible to improve the thermal impact resistance of the solder joint in the electronic parts in which coarsening of a Cu₆Sn₅ compound is suppressed. Furthermore, the fine Cu₆Sn₅ is dispersed into the Sn crystal grain boundary of the molten lead-free solder alloy, and thus it is possible to suppress a change in a crystal orientation of Sn and suppress deformation of a solder-joined shape (fillet shape).

When the amount of Cu to be included in the lead-free solder alloy is large, the Cu₆Sn₅ compound is easily precipitated in the vicinity of the joined interface as described above, and thus the lead-free solder alloy may be deteriorated in the joining reliability and the elongation properties. However, in the configuration of the lead-free alloy according to this embodiment, even when the content of Cu is 0.9 wt % to 1 wt %, the coarsening of the Cu₆Sn₅ compound can be suppressed and good elongation properties can be maintained, whereby the deterioration of the joining reliability can be suppressed.

The lead-free solder alloy of this embodiment can include 1 wt % to 5 wt % of Sb. By the addition of Sb in this range, it is possible to improve a crack propagation suppressing effect of the solder joint without deteriorating elongation properties of an Sn—Ag—Cu solder alloy. In particular, when the content of Sb is 2 wt % to 4 wt %, the crack propagation suppressing effect can be further improved.

Here, in order to withstand external stress of long-time exposure under harsh environments where a temperature difference is extreme, it is considered to be effective for increasing toughness (the size of an area enclosed by a stress-strain curve) of the lead-free solder alloy, improving the elongation properties thereof, and performing solid-solution strengthening by addition of an element for a solid solution in an Sn matrix. Sb is an optimal element to perform the solid-solution strengthening of the lead-free solder alloy while ensuring sufficient toughness and elongation properties.

That is, when Sb is added with the above range to the lead-free solder alloy substantially including Sn as a base material, a crystal lattice of Sn is partially substituted by Sb, and strain occurs in the crystal lattice. In the solder joint formed using such a lead-free solder alloy, therefore, energy required for transition in the crystal is increased by the partial substitution of Sn crystal lattice with Sb, and thus a metal structure thereof is enhanced. Furthermore, fine SnSb and 8-Ag₃(Sn, Sb) compounds precipitate in the Sn-grain boundaries, and thus slip deformation of the Sn-grain boundaries can be prevented to suppress the propagation of cracks to be generated in the solder joint.

In addition, compared to an Sn-3 AG-0.5 Cu solder alloy, it has been confirmed that the solder joint formed using the lead-free solder alloy added with Sb in the above range has a structure in which the Sn crystal is in a fine state even after the long-time exposure under the harsh environment where a temperature difference is extreme and the cracks hardly propagate. This is considered because the SnSb and s-Ag₃(Sn, Sb) compounds precipitated in the Sn-grain boundaries are finely dispersed in the solder joint even after the long-time exposure under the harsh environment where a temperature difference is extreme and thus coarsening of the Sn crystal is suppressed. In the solder joint formed using the lead-free solder alloy added with Sb in the above range, that is, since Sb is formed as a solid solution in the Sn matrix at a high-temperature state and the SnSb and ε-Ag₃(Sn, Sb) compounds precipitate at a low-temperature state, a solid-solution strengthening step and a precipitation strengthening step are repeated at the high temperature and the low temperature, respectively, even in the case of the long-time exposure under the harsh environment where the temperature difference is extreme, and thus it is considered that excellent cold-heat impact resistance can be ensured.

In the lead-free solder alloy added with Sb in the above range compared to the Sn-3 Ag-0.5 Cu solder alloy, since the strength can be improved without deterioration of the elongation properties, sufficient toughness can be ensured against external stress and residual stress can be also relieved, whereby the crack of the solder joint and the electrode flaking of the electronic part can be suppressed even in the case of the long-time exposure under the harsh environment where the temperature difference is extreme.

However, when the content of Sb exceeds 5 wt %, a melting temperature of the lead-free solder alloy rises, and Sb is not re-formed as a solid solution at a high temperature. For this reason, only precipitation strengthening is performed due to the SnSb and 8-Ag₃(Sn, Sb) compounds in the case of the long-time exposure under the severe environment where the temperature difference is extreme, and thus these intermetallic compounds become coarse with the lapse of time, and the effect of suppressing the slip deformation of the Sn-grain boundaries is lost. In this case, furthermore, a heat-resistant temperature of the electronic part can also be a problem as the melting temperature of the lead-free solder alloy rises, which is not preferred.

The lead-free solder alloy of this embodiment can include 0.05 wt % to 0.25 wt % at least one of Ni and Co. By the addition of at least one of Ni and Co in this range, even when electronic parts not subjected to Ni/Pd/Au plating are joined to each other using the lead-free solder of this embodiment, Ni and/or Co move toward the interface between the electronic part and the solder joint during the soldering to form fine (Cu, Ni)₆Sn₅ and/or (Cu, Co)₆Sn₅, and thus propagation of a Cu₃Sn layer is suppressed in the vicinity of the interface. Accordingly, the crack propagation suppressing effect is improved in the vicinity of the interface.

However, when the content of at least one of Ni and Co is less than 0.05 wt %, the amount of Ni and/or Co becomes less in the vicinity of the interface, and a reforming effect of intermetallic compounds becomes insufficient, whereby a sufficient crack suppressing effect is hard to obtain. In addition, when the content of at least one of Ni and Co exceeds 0.25 wt %, the lead-free solder alloy is likely to be oxidized, and wettability thereof is deteriorated. Therefore, the content of at least one of Ni and Co is not preferred in the above these ranges.

The content of at least one of Ni and Co is preferably 0.05 wt % to 0.25 wt %, and more preferably 0.05 wt % to 0.15 wt %.

When the lead-free solder alloy according to this embodiment includes 0.05 wt % or more of at least one of Ni and Co, the fine (Cu, Ni)₆Sn₅ or (Cu, Co)₆Sn₅ is formed (both of them are formed when both Ni and Co are included) in the interface between the electronic part and the solder joint and thus the crack propagation suppressing effect can be improved.

In addition, when the lead-free solder alloy according to this embodiment includes both Ni and Co, a mass ratio of the content of Ni to the content of Co (Ni/Co) is preferably 0.25 wt % to 4 wt %.

Furthermore, when the lead-free solder alloy according to this embodiment includes either of Ni or Co, the amount of Ni or Co to be included is preferably 0.05 wt % to 0.25 wt %, and more preferably 0.05 wt % to 0.15 wt %.

In addition, the lead-free solder alloy of this embodiment can include 6 wt % or less of In. By the addition of In in this range, the melting temperature of the lead-free solder alloy raised by the addition of Sb is lowered and the crack propagation suppressing effect can be improved at the same time. That is, similarly to Sb, since In is also formed as a solid solution in the Sn matrix, the lead-free solder alloy can be further strengthened, and the effect of suppressing slip deformation of the Sn-grain boundaries can be also achieved in such a manner that AgSnIn and InSb compounds are formed and these compounds precipitate in the Sn-grain boundaries.

When the content of In to be added to the solder alloy of this embodiment exceeds 6 wt %, it is not preferred because elongation properties of the lead-free solder alloy is deteriorated, and γ-InSn₄ is formed during the long-time exposure under the harsh environment where the temperature difference is extreme, whereby the lead-free solder alloy is also self-deformed.

The content of In is more preferably 4 wt % or less, and particularly preferably 1 wt % to 2 wt %.

Further, the lead-free solder alloy of this embodiment can include 3 wt % or less of Bi. According to the configuration of the lead-free solder alloy of this embodiment, by the addition of Bi in this range, it is possible to improve the strength of the lead-free solder alloy and lower the melting temperature raised by the addition of Sb without affecting the elongation properties of the lead-free solder alloy. That is, similarly to Sb, since Bi is also formed as a solid solution in the Sn matrix, the lead-free solder alloy can be further strengthened. However, when the content of Bi exceeds 3 wt %, it is not preferred because the elongation properties of the lead-free solder alloy is reduced and the electrode flaking is likely to be caused in the electrode parts by the solder joint formed using the lead-free solder alloy at the time of the long-time exposure under the harsh environment where the temperature difference is extreme.

The lead-free solder alloy of this embodiment can include 8 wt % or less of Zn. By the addition of Zn in this range, it is possible to improve creep resistance and crack propagation suppressing effect of the solder joint formed using the lead-free solder alloy and lower the melting temperature raised by the addition of Sb at the same time. By the addition of Zn, that is, it is possible to form an interface structure of solder joint/Cu₅5 Zn₈/Cu₆Sn₅/Cu and suppress the propagation of intermetallic compounds of the solder joint at the time of the long-time exposure under the harsh environment where the temperature difference is extreme. However, when the content of Zn exceeds 8 wt %, it is not preferred because the lead-free solder alloy is likely to be oxidized and wettability thereof is deteriorated.

The content of Zn is more preferably 5 wt % or less, and still more preferably 3 wt % or less.

The lead-free solder alloy of this embodiment can include 0.001 wt % to 0.05 wt % of at least one of Fe, Mn, Cr, and Mo. By the addition of at least one of Fe, Mn, Cr, and Mo in this range, it is possible to improve the crack propagation suppressing effect of the lead-free solder alloy. However, when the content of these elements exceeds 0.05 wt %, it is not preferred because the melting temperature of the lead-free solder alloy rises and voids are likely to occur in the solder joint.

Further, the lead-free solder alloy of this embodiment can include 0.001 wt % to 0.05 wt % of at least one of P, Ga, and Ge. By the addition of at least one of P, Ga, and Ge in this range, it is possible to prevent oxidation of the lead-free solder alloy. However, when the content of these elements exceeds 0.05 wt %, it is not preferred because the melting temperature of the lead-free solder alloy rises and voids are likely to occur in the solder joint.

Within a range not inhibiting the effects of this embodiment, the lead-free solder alloy of this embodiment can include other parts (elements), for example, Cd, Tl, Se, Au, Ti, Si, Al, and Mg. Naturally, the lead-free solder alloy of this embodiment also includes inevitable impurities.

In addition, the lead-free solder alloy of this embodiment preferably includes the balance consisting of substantially Sn.

(2) Solder Paste Composition

A solder paste composition for use in the electronic circuit board and the electronic control device of this embodiment is produced, for example, in such a manner that the lead-free solder alloy treated in a powder form and a flux are mixed with each other into a paste.

An example of the flux may include a flux including a synthetic resin, a thixotropic agent, an activator, and a solvent.

Examples of the synthetic resin may include an acrylic resin obtained by polymerization of at least one kind of monomer selected from the group consisting of acrylic acid, methacrylic acid, various esters of acrylic acid, various esters of methacrylic acid, crotonic acid, itaconic acid, maleic acid, maleic anhydride, esters of maleic acid, esters of maleic anhydride, acrylonitrile, methacrylonitrile, acrylamide, methacrylamide, vinyl chloride, and vinyl acetate; a derivative compound obtained by dehydration and condensation of a rosin-based resin having a carboxyl group and a dimer acid-derived flexible alcohol compound; an epoxy resin; a phenol resin; and a rosin-based resin. These resins may be used singly or in combination mixture of two or more kinds thereof.

In the acrylic resin, particularly, an acrylic resin is preferably used which is obtained by polymerization of the methacrylic acid and monomers including a monomer having two saturated alkyl groups, the saturated alkyl group having a straight carbon chain having 2 to 20 carbon atoms.

The rosin-based resin having the carboxyl group to be used in the derivative compound (hereinafter, referred to as “a rosin derivative compound”) obtained by dehydration and condensation of the rosin-based resin having the carboxyl group and the dimer acid-derived flexible alcohol compound may include: for example, rosin such as tall oil rosin, gum rosin, and wood rosin; and a rosin derivative such as hydrogenated rosin, polymerized rosin, disproportionated rosin, acrylic acid modified rosin, and maleic acid modified rosin. In addition to these resins, moreover, others may be used as long as being rosin having a carboxyl group. Furthermore, these resins may be used singly or in combination mixture of two or more kinds thereof.

Next, examples of the dimer acid-derived flexible alcohol compound may include a compound derived from a dimer acid such as dimer diol, polyester polyol, or polyester dimer diol and having an alcohol group at its terminal, and can make use of, for example, PRIPOL 2033, PRIPLAST 3197, or PRIPLAST 1838 (made of Croda Japan K.K).

The rosin derivative compound is obtained by dehydration and condensation of the rosin-based resin having the carboxyl group and the dimer acid-derived flexible alcohol compound. Such dehydration and condensation can be performed using a method which is commonly employed. In addition, during each of the dehydration and condensation of the rosin-based resin having the carboxyl group and the dimer acid-derived flexible alcohol compound, a preferred weight ratio of the rosin-based resin having the carboxyl group to the dimer acid-derived flexible alcohol compound is 25:75 to 75:25.

The synthetic resin has preferably an acid value 10 mg KOH/g to 150 mg KOH/g, and the amount thereof to be compounded is preferably 10 wt % to 90 wt % with respect to the total amount of flux.

Examples of the thixotropic agent may include hydrogenated castor oil, fatty acid amide, and oxyfatty acid. These may be used singly or in combination mixture of two or more kinds thereof. The amount of thixotropic agent to be compounded is preferably 3 wt % to 15 wt % with respect to the total amount of flux.

Examples of the activator may include compounds of an amine salt (inorganic acid salt and organic acid salt) such as a halogenated hydrogen salt of organic amine, organic acid, an organic acid salt, and an organic amine salt. More specifically, examples of the activator may include diphenyl guanidine hydrobromate, cyclohexyl amine hydrobromate, diethylamine hydrochloride, succinic acid, adipic acid, and sebacic acid. These may be used singly or in combination mixture of two or more kinds thereof. The amount of activator to be compounded is preferably 5 wt % to 15 wt % with respect to the total amount of flux.

Examples of the solvent may include isopropyl alcohol, ethanol, acetone, toluene, xylene, ethyl acetate, ethyl cellosolve, butyl cellosolve, and, glycol ether. These may be used singly or in combination mixture of two or more kinds thereof. The amount of solvent to be compounded is preferably 20 wt % to 40 wt % with respect to the total amount of flux.

In order to suppress oxidization of the lead-free solder alloy, an antioxidant can be compounded with the flux. Examples of the antioxidant include hindered phenolic antioxidant, phenolic antioxidant, bisphenolic antioxidant, and polymeric antioxidant. Among them, the hindered phenolic antioxidant is particularly preferably used. These may be used singly or in combination mixture of two or more kinds thereof. The amount of antioxidant to be compounded is not particularly limited. In general, the amount of antioxidant to be compounded is preferably 0.5 wt % to about 5 wt % with respect to the total amount of flux.

The flux may be added with other resins and an additive such as halogen, a flatting agent, or an antifoaming agent. The amount of additive to be compounded is preferably 10 wt % or less with respect to the total amount of flux. Furthermore, the amount of additive to be compounded is more preferably 5 wt % or less with respect to the total amount of flux.

A flux residue formed by the flux preferably maintain bonding strength of 0.2 N/mm² or more after being subjected to 2000 cycles of cold-heat impact test, one cycle being −40° C./30 min. to 125° C./30 min. By use of the flux capable of forming such a flux residue, self-curing shrinkage of the flux residue occurs to allow a substrate, a solder joint, and an electronic part to be firmly bonded to each other. For this reason, even when cracks occur in the solder joint under the environment where the temperature difference is extreme, opening of a crack surface can be prevented to disperse strain concentrated in the vicinity of a tip of the occurred crack and the propagation of the crack can be suppressed.

In this specification, the bonding strength of the flux residue is measured by the following measurement method.

A chip part is mounted on the surface of the substrate using the flux or the solder paste composition obtained using the flux, and the flux residue is formed on the substrate. The flux residue is interposed in a space surrounded by the substrate, the chip part, and the solder joint and is formed to be bonded thereto.

Then, the substrate is subjected to 2000 cycles of cold-heat impact test using a cold-heat impact tester or the like, one cycle being −40° C./30 min. to 125° C./30 min.

Then, with respect to the flux residue present on the substrate subjected to the cold-heat impact test, bonding strength is measured using an autograph or the like. Measurement conditions conform to JIS C 60068-2-21. A jig used in the measurement is a shear jig which has a width equal to or larger than the size of the part having a flat end surface. In the measurement, the shear jig abuts against the side of the chip part subjected to the cold-heat impact test to obtain a maximum test force by addition of a force parallel to the substrate at a predetermined shear speed, the obtained value is divided by an area of the chip part, and thus the bonding strength of the flux residue is calculated. At this time, a shear height is set to be ¼ or less of a height of the part, and a shear speed is set to be 5 mm/min.

A compounding ratio of the lead-free solder alloy to the flux is preferably 65:35 to 95:5 in terms of a ratio of the solder alloy to the flux. The compounding ratio is more preferably 85:15 to 93:7, and the compounding ratio is particularly preferably 89:11 to 92:8.

(3) Electronic Circuit Board

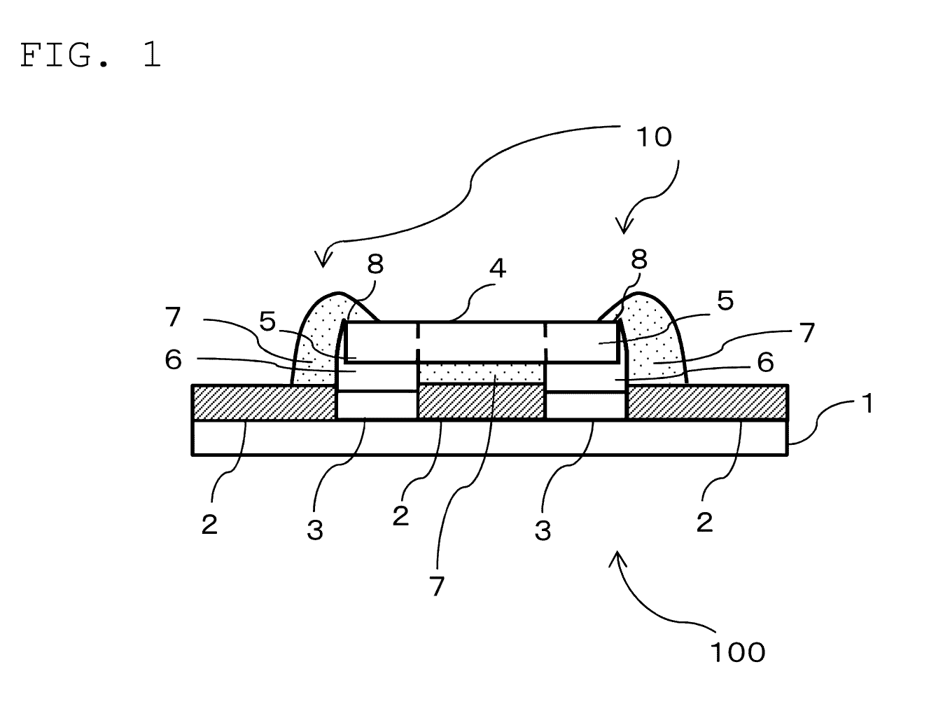

A configuration of the electronic circuit board of this embodiment will be described with reference to FIG. 1. An electronic circuit board 100 of this embodiment includes a an insulating layer 2, an electrode portion 3, an electronic part 4, and a solder joined body 10. The solder joined body 10 includes a solder joint 6 and a flux residue 7, and the electronic part 4 includes an external electrode 5 and end 8.

Examples of the substrate 1 may include a printed wiring board, a silicon wafer, and a ceramic package substrate, but may not be limited thereto as long as the electronic part can be mounted and installed.

The electrode portion 3 is electrically joined with the external electrode 5 of the electronic part 4 through the solder joint 6. In addition, the flux residue 7 fills a space surrounded by the insulating layer 2, the solder joint 6, and the electronic part 4, and is formed to be bonded thereto. In addition, the flux residue 7 is formed to cover the insulating layer 2, solder joint 6, and the end 8 of the electronic part 4.

In the electronic circuit board 100 of this embodiment having such a configuration, since the solder joint 6 is composed of alloy composition that exhibits an effect of suppressing crack propagation and electrode flaking, it is possible to suppress the crack propagation even when the cracks occur in the solder joint 6 and suppress the electrode flaking of the electronic part 4 at the same time.

In the electronic circuit board 100 of this embodiment, furthermore, the insulating layer 2, the solder joint 6, and the electronic part 4 are more firmly bonded to each other by the flux residue 7. With this configuration, it is possible to further improve the effect of suppressing the crack propagation and the electrode flaking.

Such an electronic circuit board 100 is manufactured as follows, for example.

First, the substrate 1 having the insulating layer 2 and the electrode portion 3 is formed to have a predetermined pattern, and the solder paste composition is printed according to the pattern.

Subsequently, the electronic part 4 is mounted on the substrate 1 after the printing, and then is subjected to reflowing at a temperature 220° C. to 260° C. By the reflowing, the solder joined body 10 having the solder joint 6 and the flux residue 7 is formed on the substrate 1 and the electronic circuit board 100 is manufactured at the same time in which the substrate 1 and the electronic part 4 are electrically joined to each other.

The electronic control device of this embodiment is manufactured by incorporation of such an electronic circuit board.

### EXAMPLES

The embodiment of the present invention will be described in detail using Examples and Comparative Examples. The embodiment of the present invention is not limited to these Examples.

Production of Flux

The following components were mixed with each other to obtain fluxes according to Examples and Comparative Examples.

Hydrogenated acid modified rosin (Product name: KE-604, produced by Arakawa Chemical Industries, Ltd.): 51 wt %

Hardened castor oil: 6 wt %

Eicosanedioic acid: 5 wt %

Malonic acid: 1 wt %

Diphenyl guanidine hydrobromate: 2 wt %

Hindered phenolic antioxidant (Product name: IRGANOX 245, produced by BASF Japan Ltd.): 1 wt %

Diethylene glycol monomethyl ether: 34 wt %

Production of Solder Paste Composition

By mixing of 11.0 wt % of the flux of with 89.0 wt % of powders (having a particle diameter 20 μm to 36 μm) of respective lead-free solder alloys indicated in Tables 1 to 5, respective solder paste compositions according to Examples 1 to 80 (Tables 1 to 3) and Comparative Examples 1 to 34 (Tables 4 and 5) were produced.

TΔBLE 1

| | Sn | Ag | Cu | Sb | Ni | Co | In | Bi | Zn | Others |
|---|---|---|---|---|---|---|---|---|---|---|
| Example 1 | | 3.0 | 0.5 | 1.0 | 0.15 | — | — | — | — | — |
| Example 2 | Balance | 3.0 | 0.5 | 5.0 | 0.15 | — | — | — | — | — |
| Example 3 | Balance | 3.0 | 0.9 | 1.0 | 0.15 | — | — | — | — | — |
| Example 4 | Balance | 3.0 | 0.9 | 5.0 | 0.15 | — | — | — | — | — |
| Example 5 | Balance | 3.0 | 1.0 | 1.0 | 0.15 | — | — | — | — | — |
| Example 6 | Balance | 3.0 | 1.0 | 5.0 | 0.15 | — | — | — | — | — |
| Example 7 | Balance | 1.0 | 0.5 | 1.0 | 0.15 | — | — | — | — | — |
| Example 8 | Balance | 1.0 | 0.5 | 5.0 | 0.15 | — | — | — | — | — |
| Example 9 | Balance | 2.0 | 0.5 | 1.0 | 0.15 | — | — | — | — | — |
| Example 10 | Balance | 2.0 | 0.5 | 5.0 | 0.15 | — | — | — | — | — |
| Example 11 | Balance | 3.8 | 0.5 | 1.0 | 0.15 | — | — | — | — | — |
| Example 12 | Balance | 3.8 | 0.5 | 5.0 | 0.15 | — | — | — | — | — |
| Example 13 | Balance | 4.0 | 0.5 | 1.0 | 0.15 | — | — | — | — | — |
| Example 14 | Balance | 4.0 | 0.5 | 5.0 | 0.15 | — | — | — | — | — |
| Example 15 | Balance | 3.0 | 0.5 | 5.0 | 0.05 | — | — | — | — | — |
| Example 16 | Balance | 3.0 | 0.5 | 5.0 | 0.25 | — | — | — | — | — |
| Example 17 | Balance | 3.0 | 0.5 | 5.0 | — | 0.05 | — | — | — | — |
| Example 18 | Balance | 3.0 | 0.5 | 5.0 | — | 0.15 | — | — | — | — |
| Example 19 | Balance | 3.0 | 0.5 | 5.0 | — | 0.25 | — | — | — | — |
| Example 20 | Balance | 3.0 | 0.5 | 5.0 | 0.05 | 0.20 | — | — | — | — |
| Example 21 | Balance | 3.0 | 0.5 | 5.0 | 0.10 | 0.15 | — | — | — | — |
| Example 22 | Balance | 3.0 | 0.5 | 5.0 | 0.15 | 0.10 | — | — | — | — |
| Example 23 | Balance | 3.0 | 0.5 | 5.0 | 0.20 | 0.05 | — | — | — | — |
| Example 24 | Balance | 3.0 | 0.5 | 1.0 | 0.15 | — | 0.5 | — | — | — |
| Example 25 | Balance | 3.0 | 0.5 | 5.0 | 0.15 | — | 0.5 | — | — | — |
| Example 26 | Balance | 3.0 | 0.5 | 1.0 | 0.15 | — | 4.0 | — | — | — |
| Example 27 | Balance | 3.0 | 0.5 | 5.0 | 0.15 | — | 4.0 | — | — | — |
| Example 28 | Balance | 3.0 | 0.5 | 1.0 | 0.15 | — | 6.0 | — | — | — |
| Example 29 | Balance | 3.0 | 0.5 | 5.0 | 0.15 | — | 6.0 | — | — | — |
| Example 30 | Balance | 3.0 | 0.5 | 1.0 | 0.15 | — | — | 0.5 | — | — |

TABLE 2

| | Sn | Ag | Cu | Sb | Ni | Co | In | Bi | Zn | Others |
|---|---|---|---|---|---|---|---|---|---|---|
| Example 31 | Balance | 3.0 | 0.5 | 5.0 | 0.15 | — | — | 0.5 | — | — |
| Example 32 | Balance | 3.0 | 0.5 | 1.0 | 0.15 | — | — | 1.0 | — | — |
| Example 33 | Balance | 3.0 | 0.5 | 5.0 | 0.15 | — | — | 1.0 | — | — |
| Example 34 | Balance | 3.0 | 0.5 | 1.0 | 0.15 | — | — | 2.0 | — | — |
| Example 35 | Balance | 3.0 | 0.5 | 5.0 | 0.15 | — | — | 2.0 | — | — |
| Example 36 | Balance | 3.0 | 0.5 | 1.0 | 0.15 | — | — | 3.0 | — | — |
| Example 37 | Balance | 3.0 | 0.5 | 5.0 | 0.15 | — | — | 3.0 | — | — |
| Example 38 | Balance | 3.0 | 0.5 | 1.0 | 0.15 | — | 0.5 | 0.5 | — | — |
| Example 39 | Balance | 3.0 | 0.5 | 1.0 | 0.15 | — | 4.0 | 0.5 | — | — |
| Example 40 | Balance | 3.0 | 0.5 | 1.0 | 0.15 | — | 6.0 | 0.5 | — | — |
| Example 41 | Balance | 3.0 | 0.5 | 3.0 | 0.15 | — | 0.5 | 0.5 | — | — |
| Example 42 | Balance | 3.0 | 0.5 | 3.0 | 0.15 | — | 4.0 | 0.5 | — | — |
| Example 43 | Balance | 3.0 | 0.5 | 3.0 | 0.15 | — | 6.0 | 0.5 | — | — |
| Example 44 | Balance | 3.0 | 0.5 | 5.0 | 0.15 | — | 0.5 | 0.5 | — | — |
| Example 45 | Balance | 3.0 | 0.5 | 5.0 | 0.15 | — | 4.0 | 0.5 | — | — |
| Example 46 | Balance | 3.0 | 0.5 | 5.0 | 0.15 | — | 6.0 | 0.5 | — | — |
| Example 47 | Balance | 3.0 | 0.5 | 1.0 | 0.15 | — | 0.5 | 3.0 | — | — |
| Example 48 | Balance | 3.0 | 0.5 | 1.0 | 0.15 | — | 4.0 | 3.0 | — | — |
| Example 49 | Balance | 3.0 | 0.5 | 1.0 | 0.15 | — | 6.0 | 3.0 | — | — |
| Example 50 | Balance | 3.0 | 0.5 | 3.0 | 0.15 | — | 0.5 | 3.0 | — | — |
| Example 51 | Balance | 3.0 | 0.5 | 3.0 | 0.15 | — | 4.0 | 3.0 | — | — |
| Example 52 | Balance | 3.0 | 0.5 | 3.0 | 0.15 | — | 6.0 | 3.0 | — | — |
| Example 53 | Balance | 3.0 | 0.5 | 5.0 | 0.15 | — | 0.5 | 3.0 | — | — |
| Example 54 | Balance | 3.0 | 0.5 | 5.0 | 0.15 | — | 4.0 | 3.0 | — | — |
| Example 55 | Balance | 3.0 | 0.5 | 5.0 | 0.15 | — | 6.0 | 3.0 | — | — |
| Example 56 | Balance | 3.0 | 0.5 | 1.0 | 0.15 | — | — | — | 0.5 | — |
| Example 57 | Balance | 3.0 | 0.5 | 5.0 | 0.15 | — | — | — | 0.5 | — |
| Example 58 | Balance | 3.0 | 0.5 | 1.0 | 0.15 | — | — | — | 3.0 | — |
| Example 59 | Balance | 3.0 | 0.5 | 5.0 | 0.15 | — | — | — | 3.0 | — |
| Example 60 | Balance | 3.0 | 0.5 | 1.0 | 0.15 | — | — | — | 5.0 | — |

TABLE 3

| | Sn | Ag | Cu | Sb | Ni | Co | In | Bi | Zn | Others |
|---|---|---|---|---|---|---|---|---|---|---|
| Example 61 | Balance | 3.0 | 0.5 | 5.0 | 0.15 | — | — | — | 5.0 | — |
| Example 62 | Balance | 3.0 | 0.5 | 1.0 | 0.15 | — | — | — | 8.0 | — |
| Example 63 | Balance | 3.0 | 0.5 | 5.0 | 0.15 | — | — | — | 8.0 | — |
| Example 64 | Balance | 3.0 | 0.5 | 1.0 | 0.15 | — | 0.5 | 0.5 | 0.5 | — |
| Example 65 | Balance | 3.0 | 0.5 | 1.0 | 0.15 | — | 0.5 | 0.5 | 8.0 | — |
| Example 66 | Balance | 3.0 | 0.5 | 5.0 | 0.15 | — | 6.0 | 3.0 | 0.5 | — |
| Example 67 | Balance | 3.0 | 0.5 | 5.0 | 0.15 | — | 6.0 | 3.0 | 8.0 | — |
| Example 68 | Balance | 3.0 | 0.5 | 3.0 | 0.15 | — | 4.0 | 0.5 | — | 0.05Fe |
| Example 69 | Balance | 3.0 | 0.5 | 3.0 | 0.15 | — | 4.0 | 0.5 | — | 0.05Mn |
| Example 70 | Balance | 3.0 | 0.5 | 3.0 | 0.15 | — | 4.0 | 0.5 | — | 0.05Cr |
| Example 71 | Balance | 3.0 | 0.5 | 3.0 | 0.15 | — | 4.0 | 0.5 | — | 0.05Mo |
| Example 72 | Balance | 3.0 | 0.5 | 3.0 | 0.15 | — | 4.0 | 0.5 | — | 0.05P |
| Example 73 | Balance | 3.0 | 0.5 | 3.0 | 0.15 | — | 4.0 | 0.5 | — | 0.05Ga |
| Example 74 | Balance | 3.0 | 0.5 | 3.0 | 0.15 | — | 4.0 | 0.5 | — | 0.05Ge |
| Example 75 | Balance | 3.0 | 1.0 | 3.0 | 0.05 | 0.05 | — | 3.0 | — | — |
| Example 76 | Balance | 3.0 | 0.5 | 3.0 | 0.15 | — | — | 3.0 | — | — |
| Example 77 | Balance | 3.8 | 0.5 | 3.0 | 0.15 | — | — | 3.0 | — | — |
| Example 78 | Balance | 3.0 | 0.5 | 3.0 | 0.15 | — | 1.0 | 3.0 | — | — |
| Example 79 | Balance | 3.0 | 0.5 | 3.0 | 0.15 | — | 2.0 | 3.0 | — | — |
| Example 80 | Balance | 3.0 | 0.5 | 4.0 | 0.15 | — | — | — | — | — |

TABLE 4

| | Sn | Ag | Cu | Sb | Ni | Co | In | Bi | Zn | Others |
|---|---|---|---|---|---|---|---|---|---|---|
| Comparative | Balance | 3.0 | 0.5 | — | — | — | — | — | — | — |
| Example1 | | | | | | | | | | |
| Comparative | Balance | 3.0 | 0.5 | 0.5 | 0.15 | — | — | — | — | — |
| Example2 | | | | | | | | | | |
| Comparative | Balance | 3.0 | 0.5 | 5.5 | 0.15 | — | — | — | — | — |
| Example3 | | | | | | | | | | |
| Comparative | Balance | 3.0 | 0.4 | 1.0 | 0.15 | — | — | — | — | — |
| Example4 | | | | | | | | | | |
| Comparative | Balance | 3.0 | 0.4 | 5.0 | 0.15 | — | — | — | — | — |
| Example5 | | | | | | | | | | |
| Comparative | Balance | 3.0 | 1.5 | 1.0 | 0.15 | — | — | — | — | — |
| Example6 | | | | | | | | | | |
| Comparative | Balance | 3.0 | 1.5 | 5.0 | 0.15 | — | — | — | — | — |
| Example7 | | | | | | | | | | |
| Comparative | Balance | 0.5 | 0.5 | 1.0 | 0.15 | — | — | — | — | — |
| Example8 | | | | | | | | | | |
| Comparative | Balance | 0.5 | 0.5 | 5.0 | 0.15 | — | — | — | — | — |
| Example9 | | | | | | | | | | |
| Comparative | Balance | 4.5 | 0.5 | 1.0 | 0.15 | — | — | — | — | — |
| Example10 | | | | | | | | | | |
| Comparative | Balance | 4.5 | 0.5 | 5.0 | 0.15 | — | — | — | — | — |
| Example11 | | | | | | | | | | |
| Comparative | Balance | 3.0 | 0.5 | 1.0 | 0.15 | — | 6.5 | — | — | — |
| Example12 | | | | | | | | | | |
| Comparative | Balance | 3.0 | 0.5 | 5.0 | 0.15 | — | 6.5 | — | — | — |
| Example13 | | | | | | | | | | |
| Comparative | Balance | 3.0 | 0.5 | 1.0 | 0.15 | — | — | 3.5 | — | — |
| Example14 | | | | | | | | | | |
| Comparative | Balance | 3.0 | 0.5 | 5.0 | 0.15 | — | — | 3.5 | — | — |
| Example15 | | | | | | | | | | |
| Comparative | Balance | 3.0 | 0.5 | 0.5 | 0.15 | — | 6.5 | 3.5 | — | — |
| Example16 | | | | | | | | | | |
| Comparative | Balance | 3.0 | 0.5 | 1.0 | 0.15 | — | 6.5 | 3.5 | — | — |
| Example17 | | | | | | | | | | |
| Comparative | Balance | 3.0 | 0.5 | 3.0 | 0.15 | — | 6.5 | 3.5 | — | — |
| Example18 | | | | | | | | | | |
| Comparative | Balance | 3.0 | 0.5 | 5.0 | 0.15 | — | 6.5 | 3.5 | — | — |
| Example19 | | | | | | | | | | |
| Comparative | Balance | 3.0 | 0.5 | 5.5 | 0.15 | — | 6.5 | 3.5 | — | — |
| Example20 | | | | | | | | | | |
| Comparative | Balance | 3.0 | 0.5 | 1.0 | 0.15 | — | — | — | 8.5 | — |
| Example21 | | | | | | | | | | |
| Comparative | Balance | 3.0 | 0.5 | 5.0 | 0.15 | — | — | — | 8.5 | — |
| Example22 | | | | | | | | | | |
| Comparative | Balance | 3.0 | 0.5 | 0.5 | 0.15 | — | 6.5 | 3.5 | 8.5 | — |
| Example23 | | | | | | | | | | |
| Comparative | Balance | 3.0 | 0.5 | 1.0 | 0.15 | — | 6.5 | 3.5 | 8.5 | — |
| Example24 | | | | | | | | | | |
| Comparative | Balance | 3.0 | 0.5 | 3.0 | 0.15 | — | 6.5 | 3.5 | 8.5 | — |
| Example25 | | | | | | | | | | |
| Comparative | Balance | 3.0 | 0.5 | 5.0 | 0.15 | — | 6.5 | 3.5 | 8.5 | |
| Example26 | | | | | | | | | | |
| Comparative | Balance | 3.0 | 0.5 | 5.5 | 0.15 | — | 6.5 | 3.5 | 8.5 | — |
| Example27 | | | | | | | | | | |
| Comparative | Balance | 3.0 | 0.5 | 3.0 | 0.15 | — | 4.0 | 0.5 | — | 0.1Fe |
| Example28 | | | | | | | | | | |
| Comparative | Balance | 3.0 | 0.5 | 3.0 | 0.15 | — | 4.0 | 0.5 | — | 0.1Mn |
| Example29 | | | | | | | | | | |
| Comparative | Balance | 3.0 | 0.5 | 3.0 | 0.15 | — | 4.0 | 0.5 | — | 0.1Cr |
| Example30 | | | | | | | | | | |

TABLE 5

| | Sn | Ag | Cu | Sb | Ni | Co | In | Bi | Zn | Others |
|---|---|---|---|---|---|---|---|---|---|---|
| Comparative | Balance | 3.0 | 0.5 | 3.0 | 0.15 | — | 4.0 | 0.5 | — | 0.1Mo |
| Example31 | | | | | | | | | | |
| Comparative | Balance | 3.0 | 0.5 | 3.0 | 0.15 | — | 4.0 | 0.5 | — | 0.1P |
| Example32 | | | | | | | | | | |
| Comparative | Balance | 3.0 | 0.5 | 3.0 | 0.15 | — | 4.0 | 0.5 | — | 0.1Ga |
| Example33 | | | | | | | | | | |
| Comparative | Balance | 3.0 | 0.5 | 3.0 | 0.15 | — | 4.0 | 0.5 | — | 0.1Ge |
| Example34 | | | | | | | | | | |

(1) Solder Crack Test

A glass epoxy substrate was prepared which includes a chip part having a size of 3.2 mm×1.6 mm and an electrode (1.6 mm×1.2 mm) through which a solder resist was connected to the chip part, the solder resist could being mounted with the chip part having the size, and a metal mask having a thickness of 150 μm with the same pattern was prepared.

Each of solder paste compositions was printed on the glass epoxy substrate using the metal mask, and the chip part was mounted on each of the substrates.

Thereafter, each of the glass epoxy substrates was heated using a reflow furnace (Product name: TNP-538EM, produced by Tamura Corporation) to be formed with a solder joint at which the glass epoxy substrate and the chip part were electrically joined to each other, and was mounted with the chip part. At this time, reflow conditions were as follows: preheating at 170° C. to 190° C. for 110 seconds; a peak temperature set to 245° C., in which the temperature was maintained at 200° C. or higher for 65 seconds and at 220° C. or higher for 45 seconds; a cooling rate of 2° C. to 8° C./second from the peak temperature to 200° C.; and an oxygen concentration set to 1500±500 ppm.

Next, each of the glass epoxy substrates was taken out after being exposed under an environment in which a cold-heat impact cycle was repeated 1,000, 1,500, 2,000, 2,500, and 3,000 times using a cold-heat impact tester (Product name: ES-76LMS, produced by Hitachi Appliances, Inc.) set to the condition −40° C. (for 30 minutes) to 125° C. (for 30 minutes), and each of test substrates was produced.

Then, a target portion of each test substrate was cut out, and the cut target portion was sealed using an epoxy resin (Product name: EPO MOUNT (base resin and curing agent), produced by Refinetec Co., Ltd.). Further, a central section of the chip part mounted on each test substrate was made to be seen using a wet polishing machine (Product name: TegraPol-25, produced by Marumoto Struers K.K.)), cracks occurred in the formed solder joint were observed whether to be fractured completely across the solder joint, using a scanning electron microscope (Product name: TM-1000, produced by Hitachi High-Technologies Corporation), and results were evaluated based on the following criteria. The evaluated results are indicated in Tables 6 to 10. In each of the cold-heat impact cycles, 20 chips were evaluated.

⊙: Cracks completely across the solder joint did not occur until 3,000th cycle.

◯: Cracks completely across the solder joint occurred 2,501st to 3,000th cycle.

Δ: Cracks completely across the solder joint occurred 2,001st to 2,500th cycle.

x: Cracks completely across the solder joint occurred before 2,000th cycle.

(2) Electrode Flaking Test

Each of test substrates was produced in the same conditions as in the solder crack test except that each of the glass epoxy substrates was placed under an environment in which a cold-heat impact cycle was repeated 1,000, 1,500, 2,000, 2,500, 3,000, and 3,500 times.

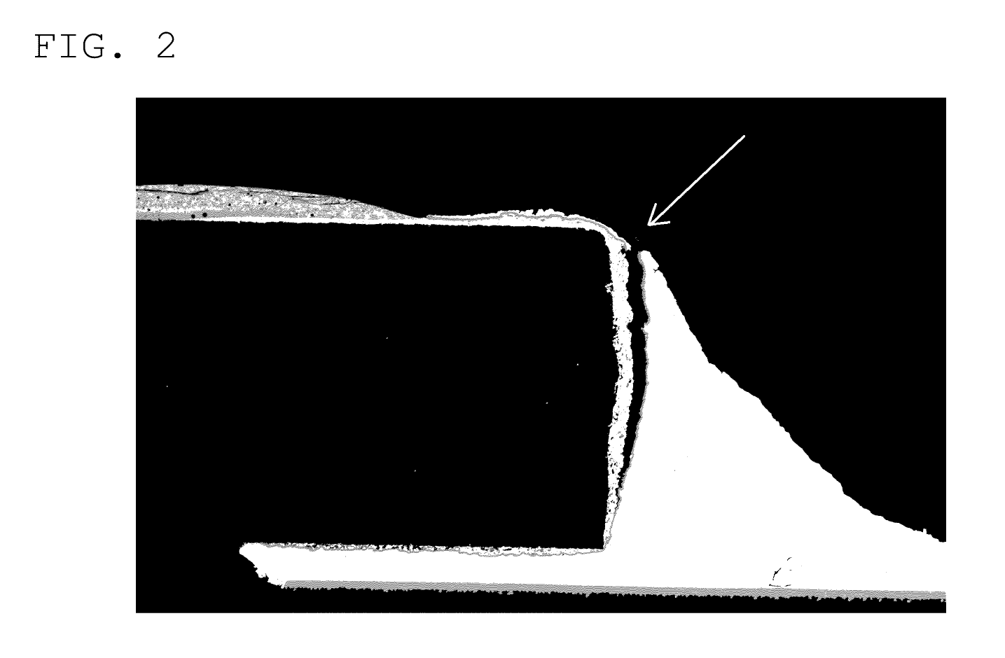

Then, a target portion of each test substrate was cut out, and the cut target portion was sealed using an epoxy resin (Product name: EPO MOUNT (base resin and curing agent), produced by Refinetec Co., Ltd.). Further, a central section of the chip part mounted on each test substrate was made to be seen using a wet polishing machine (Product name: TegraPol-25, produced by Marumoto Struers K.K.)), a phenomenon of electrode flaking of the chip part due to the solder joint was observed whether to occur as illustrated in FIG. 2, using a scanning electron microscope (Product name: TM-1000, produced by Hitachi High-Technologies Corporation), and results were evaluated as follows. In each of the cold-heat impact cycles, 20 chips were evaluated. The evaluated results are indicated in Tables 6 to 10.

⊙: Electrode flaking of the chip part did not occur until 3,500th cycle.

◯: Electrode flaking of the chip part occurred 3,001st to 3,500th cycle.

Δ: Electrode flaking of the chip part occurred 2,001st to 3,000th cycle.

x: Electrode flaking of the chip part occurred before 2,000th cycle.

(3) Solder Crack Test in an Sn-plated QFP

A glass epoxy substrate was prepared which includes a 0.5 mm chip QFP part having a size of 26 mm×26 mm×1.6 mmt (the number of leads is 176 pins, Product name: R5F5630ADDFC, produced by Renesas Electronics Corporation) and electrodes (176 electrodes of 0.25 mm×1.3 mm) through which a solder resist was connected to the QFP part, the solder resist could being mounted with the QFP part, and a metal mask having a thickness of 150 μm with the same pattern was prepared.

Each of solder paste compositions was printed on the glass epoxy substrate using the metal mask, and the QFP part was mounted on each of the substrates. Thereafter, cold-heat impact was applied to the glass epoxy substrate in the same conditions as in the solder crack test except that each of the glass epoxy substrates was placed under an environment in which a cold-heat impact cycle was repeated 1,000, 2,000, and 3,000 times, thereby producing each of test substrates.

Then, a target portion of each test substrate was cut out, and the cut target portion was sealed using an epoxy resin (Product name: EPO MOUNT (base resin and curing agent), produced by Refinetec Co., Ltd.). Further, a central section of the QFP part mounted on each test substrate was made to be seen using a wet polishing machine (Product name: TegraPol-25, produced by Marumoto Struers K.K.)), cracks occurred in the solder joint were observed whether to be fractured completely across the solder joint, using a scanning electron microscope (Product name: TM-1000, produced by Hitachi High-Technologies Corporation), and results were evaluated as follows by dividing into cracks occurred in a solder base material and cracks occurred in an interface (intermetallic compound) between the solder joint and the lead of the QFP part. The evaluated results are indicated in Tables 6 to 10. In each of the cold-heat impact cycles, 20 QFPs were evaluated. As a result, 8 leads of four corners were observed per one QFP and a total of 160 leads were confirmed in cross section.

• Cracks occurred in the solder base material

⊙: Cracks completely across the solder base material did not occur until 3,000th cycle.

◯: Cracks completely across the solder base material occurred 2,001st to 3,000th cycle.

Δ: Cracks completely across the solder base material occurred 1,001st to 2,000th cycle.

X: Cracks completely across the solder base material occurred before 1,000th cycle.

• Cracks occurred in the interface between the solder joint and the lead of the QFP part

⊙: Cracks completely across the interface did not occur until 3,000th cycle.

◯: Cracks completely across the interface occurred 2,001st to 3,000th cycle.

Δ: Cracks completely across the interface occurred 1,001st to 2,000th cycle.

x: Cracks completely across the interface occurred before 1,000th cycle.

(4) Solder Crack Test in an Sn-Plated SON

Each of test substrates was produced in the same conditions as in the solder crack test in the Sn-plated QFP except that a glass epoxy substrate was prepared which includes a 1.3 mm chip SON (Small Outline Non-leaded package) part having a size of 6 mm×5 mm×0.8 mmt (the number of terminals is 8 pins, Product name: STL60N3LLH5, produced by STMicroelectronics Corporation) and electrodes (which conforms to a maker recommendation design) through which a solder resist was connected to the SON part, the solder resist could being mounted with the SON part, and that a metal mask having a thickness of 150 μm with the same pattern was prepared. Further, cracks occurred in the solder joint were observed whether to be fractured completely across the solder joint, using a scanning electron microscope (Product name: TM-1000, produced by Hitachi High-Technologies Corporation). Based on this observation, results were evaluated as follows by dividing into cracks occurred in a solder base material and cracks occurred in an interface (intermetallic compound) between the solder joint and an electrode of the SON part. The evaluated results are indicated in Tables 6 to 10. In each of the cold-heat impact cycles, 20 SONs were evaluated. As a result, one terminal of a gate electrode was observed per one SON and a total of 20 terminals were confirmed in cross section.

• Cracks occurred in the solder base material

⊙: Cracks completely across the solder base material did not occur until 3,000th cycle.

◯: Cracks completely across the solder base material occurred 2,001st to 3,000th cycle.

Δ: Cracks completely across the solder base material occurred 1,001st to 2,000th cycle.

x: Cracks completely across the solder base material occurred before 1,000th cycle.

• Cracks occurred in the interface between the solder joint and the electrode of the SON part

⊙: Cracks completely across the interface did not occur until 3,000th cycle.

◯: Cracks completely across the interface occurred 2,001st to 3,000th cycle.

Δ: Cracks completely across the interface occurred 1,001st to 2,000th cycle.

x: Cracks completely across the interface occurred before 1,000th cycle.

(5) Measurement of Liquidus Line

With respect to each of the lead-free solder alloys according to Examples and Comparative Examples, a liquidus temperature was measured using differential scanning calorimeter (Product name: EXSTAR DSC6200, produced by Seiko Instruments Inc.). Measurement conditions were as follows: a temperature rising rate being 10° C./min from a room temperature to 150° C. and 2° C./rain 150° C. to 250° C. The sample volume was set to be 10 mg. Results are indicated in Tables 6 to 10.

(6) Void Test

Each of test substrates in which a chip part was mounted on each of glass epoxy substrates was produced in such a manner that as in the solder crack test. Then, a surface condition of each test substrate was observed by an X-ray transmission device (Product name: SMX-160E, produced by Shimadzu Corporation), and a rate of a total area of voids (an area ratio of voids) was measured which occupied a region where the solder joint was formed. An average value of the area ratio of voids for 40 lands in each test substrate was obtained, and thus generation status of voids was evaluated as follows. The results were indicated in Tables 6 to 10.

⊙: Average value of the area ratio of voids was 3% or less, and an effect of void generation suppression was extremely good.

◯: Average value of the area ratio of voids was more than 3% but equal to or less than 5%, and an effect of void generation suppression was good.

Δ: Average value of the area ratio of voids was more than 5% but equal to or less than 10%, and an effect of void generation suppression was sufficient.

x: Average value of the area ratio of voids was more than 10% but equal to or less than 15%, and an effect of void generation suppression was insufficient.

(8) Cu Erosion Test

An FR4 substrate having copper wiring of 35 μm in thickness was cut to an appropriate size. After a pre-flux was applied to the surface of the copper wiring of the FR4 substrate, the surface of the copper wiring was pre-heated for 60 seconds, and thus the temperature of the test substrate was set to approximately 120° C. Subsequently, a wave soldering bath was prepared in which each lead-free solder alloy according to Examples and Comparative Examples are melted, each test substrate was immersed for 3 seconds in a spouted-molten solder by placing it 2 mm above a spouting port of the wave soldering bath. This immersing process was performed repeatedly, and the number of times of immersion was measured until the size of the copper wiring on the test substrate was reduced by half, whereby evaluation was performed as follows. The results were indicated in Tables 6 to 10.

◯: The size of the copper wiring was not reduced even in four or more times of immersion.

x: The size of the copper wiring was reduced in three or less of immersion.

TABLE 6

| | | | Crack in Sn- | | Crack in Sn- | | | | |
|---|---|---|---|---|---|---|---|---|---|
| | | Crack in | plated QFP | | plated SON | | Liquidus | | |
| | | Sn-plated | Base | | Base | | line | | Cu |
| | Crack | QFP | material | Interface | material | Interface | (° C.) | Void | erosion |
| Example1 | Δ | ⊚ | ◯ | ⊚ | ◯ | ⊚ | 225 | ⊚ | ◯ |
| Example2 | ⊚ | ⊚ | ⊚ | ⊚ | ⊚ | ⊚ | 235 | ◯ | ◯ |
| Example3 | ◯ | ⊚ | ◯ | ⊚ | ◯ | ⊚ | 223 | Δ | ◯ |
| Example4 | ⊚ | ⊚ | ⊚ | ⊚ | ⊚ | ⊚ | 233 | Δ | ◯ |
| Example5 | ◯ | ⊚ | ◯ | Δ | ◯ | Δ | 223 | Δ | ◯ |
| Example6 | ⊚ | ⊚ | ⊚ | Δ | ⊚ | Δ | 233 | Δ | ◯ |
| Example7 | Δ | ⊚ | ◯ | ⊚ | ◯ | ⊚ | 229 | Δ | ◯ |
| Example8 | Δ | ⊚ | ◯ | ⊚ | ◯ | ⊚ | 239 | Δ | ◯ |
| Example9 | Δ | ⊚ | ◯ | ⊚ | ◯ | ⊚ | 227 | Δ | ◯ |
| Example10 | ◯ | ⊚ | ⊚ | ⊚ | ⊚ | ⊚ | 237 | Δ | ◯ |
| Example11 | ◯ | ⊚ | ⊚ | ⊚ | ⊚ | ⊚ | 223 | ◯ | ◯ |
| Example12 | ⊚ | ⊚ | ⊚ | ⊚ | ⊚ | ⊚ | 233 | ◯ | ◯ |
| Example13 | ◯ | ⊚ | ⊚ | ⊚ | ⊚ | ⊚ | 223 | Δ | ◯ |
| Example14 | ⊚ | ⊚ | ⊚ | ⊚ | ⊚ | ⊚ | 233 | Δ | ◯ |
| Example15 | ⊚ | ⊚ | ⊚ | ◯ | ⊚ | ◯ | 234 | ⊚ | ◯ |
| Example16 | ⊚ | ⊚ | ⊚ | ⊚ | ⊚ | ⊚ | 237 | Δ | ◯ |
| Example17 | ⊚ | ⊚ | ⊚ | ◯ | ⊚ | ◯ | 233 | ⊚ | ◯ |
| Example18 | ⊚ | ⊚ | ⊚ | ⊚ | ⊚ | ⊚ | 235 | ◯ | ◯ |
| Example19 | ⊚ | ⊚ | ⊚ | ⊚ | ⊚ | ⊚ | 236 | Δ | ◯ |
| Example20 | ⊚ | ⊚ | ⊚ | ⊚ | ⊚ | ⊚ | 236 | Δ | ◯ |
| Example21 | ⊚ | ⊚ | ⊚ | ⊚ | ⊚ | ⊚ | 236 | Δ | ◯ |
| Example22 | ⊚ | ⊚ | ⊚ | ⊚ | ⊚ | ⊚ | 237 | Δ | ◯ |
| Example23 | ⊚ | ⊚ | ⊚ | ⊚ | ⊚ | ⊚ | 237 | Δ | ◯ |
| Example24 | Δ | ⊚ | ◯ | ⊚ | ◯ | ⊚ | 224 | ⊚ | ◯ |
| Example25 | ⊚ | ⊚ | ⊚ | ⊚ | ⊚ | ⊚ | 234 | ◯ | ◯ |
| Example26 | Δ | ⊚ | ⊚ | ⊚ | ⊚ | ⊚ | 217 | ◯ | ◯ |
| Example27 | ⊚ | ⊚ | ⊚ | ⊚ | ⊚ | ⊚ | 227 | ◯ | ◯ |
| Example28 | Δ | ⊚ | ⊚ | ⊚ | ⊚ | ⊚ | 213 | Δ | ◯ |
| Example29 | ⊚ | ⊚ | ⊚ | ⊚ | ⊚ | ⊚ | 223 | Δ | ◯ |
| Example30 | Δ | ⊚ | ◯ | ⊚ | ◯ | ⊚ | 224 | ⊚ | ◯ |

TABLE 7

| | | | Crack in Sn- | | Crack in Sn- | | | | |
|---|---|---|---|---|---|---|---|---|---|
| | | Crack in | plated QFP | | plated SON | | Liquidus | | |
| | | Sn-plated | Base | | Base | | line | | Cu |
| | Crack | QFP | material | Interface | material | Interface | (° C.) | Void | erosion |
| Example31 | ⊚ | ⊚ | ⊚ | ⊚ | ⊚ | ⊚ | 234 | ◯ | ◯ |
| Example32 | ◯ | ◯ | ◯ | ⊚ | ◯ | ⊚ | 224 | ⊚ | ◯ |
| Example33 | ⊚ | ◯ | ⊚ | ⊚ | ⊚ | ⊚ | 234 | ◯ | ◯ |
| Example34 | ◯ | Δ | ⊚ | ⊚ | ⊚ | ⊚ | 223 | ◯ | ◯ |
| Example35 | ⊚ | Δ | ⊚ | ⊚ | ⊚ | ⊚ | 233 | ◯ | ◯ |
| Example36 | ◯ | Δ | ⊚ | ⊚ | ⊚ | ⊚ | 222 | ◯ | ◯ |
| Example37 | ⊚ | Δ | ⊚ | ⊚ | ⊚ | ⊚ | 232 | ◯ | ◯ |
| Example38 | Δ | ⊚ | ◯ | ⊚ | ◯ | ⊚ | 223 | ⊚ | ◯ |
| Example39 | Δ | ⊚ | ⊚ | ⊚ | ⊚ | ⊚ | 216 | ◯ | ◯ |
| Example40 | Δ | ⊚ | ⊚ | ⊚ | ⊚ | ⊚ | 212 | Δ | ◯ |
| Example41 | Δ | ⊚ | ⊚ | ⊚ | ⊚ | ⊚ | 225 | ⊚ | ◯ |
| Example42 | ⊚ | ⊚ | ⊚ | ⊚ | ⊚ | ⊚ | 218 | ◯ | ◯ |
| Example43 | ⊚ | ⊚ | ⊚ | ⊚ | ⊚ | ⊚ | 214 | Δ | ◯ |
| Example44 | ⊚ | ⊚ | ⊚ | ⊚ | ⊚ | ⊚ | 233 | ◯ | ◯ |
| Example45 | ⊚ | ⊚ | ⊚ | ⊚ | ⊚ | ⊚ | 226 | ◯ | ◯ |
| Example46 | ⊚ | ⊚ | ⊚ | ⊚ | ⊚ | ⊚ | 222 | Δ | ◯ |
| Example47 | ⊚ | Δ | ⊚ | ⊚ | ⊚ | ⊚ | 221 | ◯ | ◯ |
| Example48 | ⊚ | Δ | ⊚ | ⊚ | ⊚ | ⊚ | 213 | ◯ | ◯ |
| Example49 | ⊚ | Δ | ⊚ | ⊚ | ⊚ | ⊚ | 209 | Δ | ◯ |
| Example50 | ⊚ | Δ | ⊚ | ⊚ | ⊚ | ⊚ | 223 | ◯ | ◯ |
| Example51 | ⊚ | Δ | ⊚ | ⊚ | ⊚ | ⊚ | 215 | Δ | ◯ |
| Example52 | ⊚ | Δ | ⊚ | ⊚ | ⊚ | ⊚ | 211 | Δ | ◯ |
| Example53 | ⊚ | Δ | ⊚ | ⊚ | ⊚ | ⊚ | 231 | ⊚ | ◯ |
| Example54 | ⊚ | Δ | ⊚ | ⊚ | ⊚ | ⊚ | 223 | Δ | ◯ |
| Example55 | ⊚ | Δ | ⊚ | ⊚ | ⊚ | ⊚ | 219 | Δ | ◯ |
| Example56 | Δ | ⊚ | ◯ | ⊚ | ◯ | ⊚ | 223 | ⊚ | ◯ |
| Example57 | ⊚ | ⊚ | ⊚ | ⊚ | ⊚ | ⊚ | 233 | ◯ | ◯ |
| Example58 | Δ | ⊚ | ⊚ | ⊚ | ⊚ | ⊚ | 216 | ⊚ | ◯ |
| Example59 | ⊚ | ⊚ | ⊚ | ⊚ | ⊚ | ⊚ | 226 | ◯ | ◯ |
| Example60 | Δ | ⊚ | ◯ | ⊚ | ◯ | ⊚ | 210 | Δ | ◯ |

TABLE 8

| | | | Crack in Sn- | | Crack in Sn- | | | | |
|---|---|---|---|---|---|---|---|---|---|
| | | Crack in | plated QFP | | plated SON | | Liquidus | | |
| | | Sn-plated | Base | | Base | | line | | Cu |
| | Crack | QFP | material | Interface | material | Interface | (° C.) | Void | erosion |
| Example61 | ◯ | ⊚ | ◯ | ⊚ | ◯ | ⊚ | 220 | Δ | ◯ |
| Example62 | Δ | ⊚ | ◯ | ⊚ | ◯ | ⊚ | 201 | Δ | ◯ |
| Example63 | Δ | ⊚ | ◯ | ⊚ | ◯ | ⊚ | 211 | Δ | ◯ |
| Example64 | Δ | ⊚ | ◯ | ⊚ | ◯ | ⊚ | 222 | ⊚ | ◯ |
| Example65 | Δ | ⊚ | ◯ | ⊚ | ◯ | ⊚ | 199 | Δ | ◯ |
| Example66 | ⊚ | Δ | ⊚ | ⊚ | ⊚ | ⊚ | 217 | Δ | ◯ |
| Example67 | Δ | Δ | ◯ | ⊚ | ◯ | ⊚ | 194 | Δ | ◯ |
| Example68 | ⊚ | ⊚ | ⊚ | ⊚ | ⊚ | ⊚ | 219 | ◯ | ◯ |
| Example69 | ⊚ | ⊚ | ⊚ | ⊚ | ⊚ | ⊚ | 219 | ◯ | ◯ |
| Example70 | ⊚ | ⊚ | ⊚ | ⊚ | ⊚ | ⊚ | 219 | ◯ | ◯ |
| Example71 | ⊚ | ⊚ | ⊚ | ⊚ | ⊚ | ⊚ | 219 | ◯ | ◯ |
| Example72 | ⊚ | ⊚ | ⊚ | ⊚ | ⊚ | ⊚ | 219 | ◯ | ◯ |
| Example73 | ⊚ | ⊚ | ⊚ | ⊚ | ⊚ | ⊚ | 219 | ◯ | ◯ |
| Example74 | ⊚ | ⊚ | ⊚ | ⊚ | ⊚ | ⊚ | 219 | ◯ | ◯ |
| Example75 | ⊚ | Δ | ⊚ | ⊚ | ⊚ | ⊚ | 222 | Δ | ◯ |
| Example76 | ⊚ | Δ | ⊚ | ⊚ | ⊚ | ⊚ | 223 | ◯ | ◯ |
| Example77 | ⊚ | ◯ | ⊚ | ⊚ | ⊚ | ⊚ | 222 | ◯ | ◯ |
| Example78 | ⊚ | Δ | ⊚ | ⊚ | ⊚ | ⊚ | 221 | ◯ | ◯ |
| Example79 | ⊚ | Δ | ⊚ | ⊚ | ⊚ | ⊚ | 219 | ◯ | ◯ |
| Example80 | ⊚ | ⊚ | ⊚ | ⊚ | ⊚ | ⊚ | 232 | ◯ | ◯ |

TABLE 9

| | | | Crack in Sn- | | Crack in Sn- | | | | |
|---|---|---|---|---|---|---|---|---|---|
| | | Crack in | plated QFP | | plated SON | | Liquidus | | |
| | | Sn-plated | Base | | Base | | line | | Cu |
| | Crack | QFP | material | Interface | material | Interface | (° C.) | Void | erosion |
| Comparative | X | ⊚ | Δ | Δ | Δ | Δ | 220 | ⊚ | ◯ |
| Example1 | | | | | | | | | |
| Comparative | X | ⊚ | X | ⊚ | X | ⊚ | 223 | ⊚ | ◯ |
| Example2 | | | | | | | | | |
| Comparative | Δ | ⊚ | ◯ | ⊚ | ◯ | ⊚ | 237 | X | ◯ |
| Example3 | | | | | | | | | |
| Comparative | Δ | ⊚ | ◯ | ⊚ | ◯ | ⊚ | 225 | ⊚ | X |
| Example4 | | | | | | | | | |
| Comparative | ⊚ | ⊚ | ◯ | ⊚ | ◯ | ⊚ | 235 | ⊚ | X |
| Example5 | | | | | | | | | |
| Comparative | Δ | ⊚ | ◯ | X | ◯ | X | 222 | X | ◯ |
| Example6 | | | | | | | | | |
| Comparative | ◯ | ⊚ | ◯ | X | ◯ | X | 232 | X | ◯ |
| Example7 | | | | | | | | | |
| Comparative | X | ⊚ | Δ | ⊚ | Δ | ⊚ | 230 | X | ◯ |
| Example8 | | | | | | | | | |
| Comparative | Δ | ⊚ | ◯ | ⊚ | ◯ | ⊚ | 240 | X | ◯ |
| Example9 | | | | | | | | | |
| Comparative | Δ | ⊚ | ◯ | ⊚ | ◯ | ⊚ | 222 | X | ◯ |
| Example10 | | | | | | | | | |
| Comparative | ◯ | ⊚ | ◯ | ⊚ | ◯ | ⊚ | 232 | X | ◯ |
| Example11 | | | | | | | | | |
| Comparative | Δ | ⊚ | ◯ | ⊚ | ◯ | ⊚ | 211 | X | ◯ |
| Example12 | | | | | | | | | |
| Comparative | Δ | ⊚ | ◯ | ⊚ | ◯ | ⊚ | 221 | X | ◯ |
| Example13 | | | | | | | | | |
| Comparative | ⊚ | X | ⊚ | ⊚ | ⊚ | ⊚ | 221 | ◯ | ◯ |
| Example14 | | | | | | | | | |
| Comparative | ⊚ | X | ⊚ | ⊚ | ⊚ | ⊚ | 231 | ◯ | ◯ |
| Example15 | | | | | | | | | |
| Comparative | Δ | X | ◯ | ⊚ | ◯ | ⊚ | 206 | X | ◯ |
| Example16 | | | | | | | | | |
| Comparative | Δ | X | ◯ | ⊚ | ◯ | ⊚ | 207 | X | ◯ |
| Example17 | | | | | | | | | |
| Comparative | Δ | X | ◯ | ⊚ | ◯ | ⊚ | 209 | X | ◯ |
| Example18 | | | | | | | | | |
| Comparative | Δ | X | ◯ | ⊚ | ◯ | ⊚ | 217 | X | ◯ |
| Example19 | | | | | | | | | |
| Comparative | Δ | X | ◯ | ⊚ | ◯ | ⊚ | 219 | X | ◯ |
| Example20 | | | | | | | | | |
| Comparative | X | ⊚ | Δ | ⊚ | Δ | ⊚ | 200 | X | ◯ |
| Example21 | | | | | | | | | |
| Comparative | Δ | ⊚ | ◯ | ⊚ | ◯ | ⊚ | 210 | X | ◯ |
| Example22 | | | | | | | | | |
| Comparative | X | X | X | ⊚ | X | ⊚ | 180 | X | ◯ |
| Example23 | | | | | | | | | |
| Comparative | X | X | Δ | ⊚ | Δ | ⊚ | 181 | X | ◯ |
| Example24 | | | | | | | | | |
| Comparative | Δ | X | ◯ | ⊚ | ◯ | ⊚ | 183 | X | ◯ |
| Example25 | | | | | | | | | |
| Comparative | Δ | X | ◯ | ⊚ | ◯ | ⊚ | 191 | X | ◯ |
| Example26 | | | | | | | | | |
| Comparative | Δ | X | ◯ | ⊚ | ◯ | ⊚ | 193 | X | ◯ |
| Example27 | | | | | | | | | |
| Comparative | ◯ | ⊚ | ⊚ | ⊚ | ⊚ | ⊚ | 221 | X | ◯ |
| Example28 | | | | | | | | | |
| Comparative | ◯ | ⊚ | ⊚ | ⊚ | ⊚ | ⊚ | 221 | X | ◯ |
| Example29 | | | | | | | | | |
| Comparative | ◯ | ⊚ | ⊚ | ⊚ | ⊚ | ⊚ | 221 | X | ◯ |
| Example30 | | | | | | | | | |

TABLE 10

| | | | Crack in Sn- | | Crack in Sn- | | | | |
|---|---|---|---|---|---|---|---|---|---|
| | | Crack in | plated QFP | | plated SON | | Liquidus | | |
| | | Sn-plated | Base | | Base | | line | | Cu |
| | Crack | QFP | material | Interface | material | Interface | (° C.) | Void | erosion |
| Comparative | ◯ | ⊚ | ⊚ | ⊚ | ⊚ | ⊚ | 221 | X | ◯ |
| Example31 | | | | | | | | | |
| Comparative | ◯ | ⊚ | ⊚ | ⊚ | ⊚ | ⊚ | 221 | X | ◯ |
| Example32 | | | | | | | | | |
| Comparative | ◯ | ⊚ | ⊚ | ⊚ | ⊚ | ⊚ | 221 | X | ◯ |
| Example33 | | | | | | | | | |
| Comparative | ◯ | ⊚ | ⊚ | ⊚ | ⊚ | ⊚ | 221 | X | ◯ |
| Example34 | | | | | | | | | |

In the solder joint formed using the lead-free solder alloys according to Examples as described above, the crack propagation can be suppressed and the electrode flaking of the electronic part due to the solder joint can be suppressed even under the harsh environment where the temperature difference is extreme and the vibration is loaded and even when the electronic part plated with Sn is used. Even when the amount of Bi to be compounded is 3.0 wt % or less, it is possible to suppress the crack propagation and electrode flaking phenomenon without deteriorating the elongation properties.

Furthermore, in the lead-free solder alloy compounded with In, especially, it is possible to decrease the liquidus line without deteriorating the effect of suppressing the crack propagation and the electrode flaking.

Accordingly, the electronic circuit board having such a solder joint can be also suitably used for an electronic circuit board such as the in-vehicle electronic circuit board for which high reliability is required. Moreover, such an electronic circuit board can be suitably used for an electronic control device for which higher reliability is required.

In the related art, a solder joining method using a solder paste composition is employed at the time of joining an electronic part to an electronic circuit formed on a printed wiring board or a silicon wafer substrate. In general, as the solder paste composition, a solder alloy including lead was used. However, since the use of lead has been restricted by RoHS directive or the like from the viewpoint of environmental loads, a solder joining method using a so-called lead-free solder alloy including no lead has become common in recent years.

As the lead-free solder alloy, for example, Sn—Cu, Sn—Ag—Cu, Sn—Bi, and Sn—Zn solder alloys are well known. Among the alloys, an Sn-3Ag-0.5Cu solder alloy is much used for consumer electronic equipment to be used in televisions, mobile phones, or the like and in-vehicle electronic equipment to be mounted on vehicles.

Although the lead-free solder alloy is somewhat inferior to a lead-including solder alloy in solderability, the problem of solderability is covered by a flux or improvement of a soldering apparatus. Therefore, for example, in an in-vehicle electronic circuit board placed in a passenger compartment of a vehicle which is under a relatively moderate environment but has a temperature difference, a solder joint formed using the Sn-3Ag-0.5Cu solder alloy also has not caused large problems.

However, for example, as in an electronic circuit board to be used in an electronic control device, under the harsh environment where the temperature difference is particularly extreme (for example, the temperature difference is −30° C. to 110° C., −40° C. to 125° C., and −40° C. to 150° C.) and vibration is loaded, an arrangement of an electronic circuit board which is directly mounted on an engine compartment or an engine and is mechanically and electrically integrated with a motor has been studied and put to practical use in recent years. Under such a harsh environment where the temperature difference in extreme, large stress occurs in the solder joint due to a difference in linear expansion coefficient between the mounted electronic part and a substrate. With cold-heat cycles, the stress repeatedly occurring in the solder joint causes repeatedly plastic deformation of the solder joint over and over. For this reason, cracks are likely to occur in the repeatedly and plastically deformed solder joint, and the cracks are likely to traversely propagate up to a deep portion of the solder joint because strain concentrates on the solder joint in the vicinity of the tip of the occurred cracks. In addition, under an environment where vibration is loaded to the electronic circuit board in addition to the environment where the temperature difference is extreme, cracks and propagation thereof are likely to occur. Thus, the significantly propagated cracks will cut electrical connection between an electronic part and an electronic circuit formed on the substrate.

With an increase of the in-vehicle electronic circuit board and the electronic control device placed in the above-described harsh environment, a request for a solder paste composition using the Sn—Ag—Cu solder alloy capable of exhibiting a sufficient crack propagation suppressing effect is expected to be increased in the future.

Further, in the related art, a part plated with Ni/Pd/Au was frequently used in a lead portion of the electronic part such as QFP (Quad Flat Package) or SOP (Small Outline Package) mounted on the in-vehicle electronic circuit board. However, according to cost reduction of the electronic part or downsizing of the substrate in recent years, an electronic part having an Sn-plated lead portion or an electronic part having a bottom electrode has been studied and put to practical use.

During solder joining, the electronic part plated with Sn is likely to cause mutual diffusion between Sn included in the Sn plating and the solder joint and Cu included in the lead portion or the bottom electrode. By the mutual diffusion, in the vicinity of an interface between the lead portion and the solder joint and an interface between the bottom electrode and the solder joint, a Cu₃Sn layer as an intermetallic compound significantly propagates in an uneven shape. The Cu₃Sn layer is originally hard and brittle nature, and the Cu₃Sn layer which propagates significantly in the uneven shape becomes more brittle. Therefore, under the above-described harsh environment in particular, cracks are likely to occur in the vicinity of the interface compared to the solder joint, the occurred cracks propagate at once from the interface as a starting point, and thus an electrical short is likely to occur in the vicinity of the interface.

Accordingly, even when an electronic part not plated with Ni/Pd/Au is used under the harsh environment as described above, a request for a lead-free solder alloy capable of exhibiting the sufficient crack propagation suppressing effect in the vicinity of the interface is also expected to be largely increased in the future.

Methods of increasing strength of a lead-free solder alloy by adding Ag or Bi to the solder alloy having Sn as base material are disclosed in several documents (see JP H5-228685 A, JP H9-326554 A, JP 2000-190090 A, JP 2000-349433 A, JP 2008-28413 A, WO 2009/011341 A, and JP 2012-81521 A). However, when once cracks occur in the solder joint, it is difficult to suppress the propagation of the cracks only by the increase of the strength of the lead-free solder alloy.

Furthermore, the lead-free solder alloy which is highly strengthened by the addition of Bi also has a disadvantage that elongation properties deteriorate. When the applicant observed the solder joint formed using the lead-free solder alloy according to the related art added with Bi under the harsh environment where a temperature difference is extreme, a certain crack propagation suppressing effect was seen in the solder joint, but it was confirmed that a phenomenon occurred that electrode flaking of the electronic part was caused by the solder joint, resulting in a short circuit of the electrode. When a chip part having a size of 3.2 mm×1.6 mm was used, such a phenomenon was significantly observed.

Normally, a solder alloy is solidified from an electronic circuit side of a substrate to an electrode side of an electronic part during a cooling process in a solder joining process by reflowing, and a solder joint is formed. For this reason, residual stress is likely to be accumulated in an upper portion of the solder joint. Here, in the lead-free solder alloy having the elongation properties lowered by the addition of Bi, the residual stress is hard to be relieved, and cracks are likely to occur from the vicinity of the electrode of the electronic part to the deep portion of the solder joint under the environment where the temperature difference is extreme in particular. As a result, strain concentrates on the electrode of the electronic part in the vicinity of the crack, and thus it is assumed that the electrode of the electronic part side is flaked by the solder joint.

This phenomenon is not confirmed in the Sn-3Ag-0.5Cu solder alloy having excellent elongation properties. Therefore, this phenomenon is regarded as an adverse effect caused by the lead-free solder alloy added with Bi. That is, it is considered to be difficult to suppress the electrode flaking of the electronic part only by the increase of the strength of the lead-free solder alloy.

When the solder joining is performed using the electronic part not plated with Ni/Pd/Au, since the Cu₃Sn layer as the intermetallic compound significantly propagates in the uneven shape in the vicinity of the interface between the lead portion and the solder joint and the interface between the bottom electrode and the solder joint, it is difficult to suppress the crack propagation in the vicinity of the interface.

(1) A lead-free solder alloy according to an embodiment of the present invention includes: 1 wt % to 4 wt % of Ag; 0.5 wt % to 1 wt % of Cu; 1 wt % to 5 wt % of Sb; 0.05 wt % to 0.25 wt % at least one of Ni and Co; and Sn.

(2) In the configuration according to the above (1), the lead-free solder alloy further includes 6 wt % or less of In.

(3) In the configuration according to the above (1) or (2), the lead-free solder alloy further includes 3 wt % or less of Bi.

(4) In the configuration according to any one of the above (1) to (3), the lead-free solder alloy further includes 8 wt % or less of Zn.

(5) In the configuration according to any one of the above (1) to (4), the lead-free solder alloy further includes 0.001 wt % to 0.05 wt % at least one of Fe, Mn, Cr, and Mo.

(6) In the configuration according to any one of the above (1) to (5), the lead-free solder alloy further includes 0.001 wt % to 0.05 wt % at least one of P, Ga, and Ge.

(7) An electronic circuit board according to an embodiment of the present invention includes a solder joint formed using the lead-free solder alloy according to any one of the above (1) to (6).

(8) An electronic control device according to an embodiment of the present invention includes the electronic circuit board according to the above (7).

According to the lead-free solder alloy, the electronic circuit board having the solder joint, and the electronic control device, it is possible to suppress both of crack propagation in a solder joint and electrode flaking of an electronic part due to the solder joint even under an environment where a temperature difference is extreme and vibration is loaded and to suppress crack propagation in the vicinity of an interface between the electronic part and the solder joint even in a case where solder joining is performed using an electronic part not plated with Ni/Pd/Au.

Obviously, numerous modifications and variations of the present invention are possible in light of the above teachings. It is therefore to be understood that within the scope of the appended claims, the invention may be practiced otherwise than as specifically described herein.

What is claimed is:

1. A lead-free solder alloy comprising:
1 wt % to 4 wt % of Ag;
0.5 wt % to 1 wt % of Cu;
1 wt % to 5 wt % of Sb;
0.05 wt % to 0.25 wt % of at least one of Ni and Co; and
Sn.

2. The lead-free solder alloy according to claim 1, further comprising 3 wt % or less of Bi.

3. The lead-free solder alloy according to claim 1, further comprising 6 wt % or less of In.

4. The lead-free solder alloy according to claim 2, further comprising 6 wt % or less of In.

5. The lead-free solder alloy according to claim 1, further comprising 0.001 wt % to 0.05 wt % of at least one of P, Ga, and Ge.

6. The lead-free solder alloy according to claim 2, further comprising 0.001 wt % to 0.05 wt % of at least one of P, Ga, and Ge.

7. The lead-free solder alloy according to claim 3, further comprising 0.001 wt % to 0.05 wt % of at least one of P, Ga, and Ge.

8. The lead-free solder alloy according to claim 4, further comprising 0.001 wt % to 0.05 wt % of at least one of P, Ga, and Ge.

9. The lead-free solder alloy according to claim 1, further comprising 0.001 wt % to 0.05 wt % of at least one of Fe, Mn, Cr, and Mo.

10. The lead-free solder alloy according to claim 2, further comprising 0.001 wt % to 0.05 wt % of at least one of Fe, Mn, Cr, and Mo.

11. An electronic circuit board comprising a solder joint including a lead-free solder alloy comprising:
1 wt % to 4 wt % of Ag;
0.5 wt % to 1 wt % of Cu;
1 wt % to 5 wt % of Sb;
0.05 wt % to 0.25 wt % of at least one of Ni and Co; and
Sn.

12. The electronic circuit board according to claim 11, the lead-free solder alloy further comprising 3 wt % or less of Bi.

13. The electronic circuit board according to claim 11, the lead-free solder alloy further comprising 6 wt % or less of In.

14. The electronic circuit board according to claim 11, the lead-free solder alloy further comprising 0.001 wt % to 0.05 wt % of at least one of P, Ga, and Ge.

15. An electronic control device comprising the electronic circuit board having a solder joint including a lead-free solder alloy comprising:
1 wt % to 4 wt % of Ag;
0.5 wt % to 1 wt % of Cu;
1 wt % to 5 wt % of Sb;
0.05 wt % to 0.25 wt % of at least one of Ni and Co; and
Sn.

16. The electronic control device according to claim 15, the lead-free solder alloy further comprising 3 wt % or less of Bi.

17. The electronic control device according to claim 15, the lead-free solder alloy further comprising 6 wt % or less of In.

18. The electronic control device according to claim 15, the lead-free solder alloy further comprising 0.001 wt % to 0.05 wt % of at least one of P, Ga, and Ge.

19. The lead-free solder alloy according to claim 1, wherein the Sn is substantially a balance of the lead-free solder alloy.

20. The electronic circuit board according to claim 11, wherein the Sn is substantially a balance of the lead-free solder alloy.
